(19) United States
(12) Patent Application Publication
(10) Pub. No.: US 2018/0258883 A1
(43) Pub. Date: Sep. 13, 2018

(54) METHOD FOR CONTROLLING THE PRESSURE AND A MIXTURE RATIO OF A ROCKET ENGINE, AND CORRESPONDING DEVICE

(71) Applicant: AIRBUS SAFRAN LAUNCHERS, Issy les Moulineaus (FR)

(72) Inventor: Serge Daniel LE GONIDEC, Vernon (FR)

(73) Assignee: ARIANEGROUP SAS, Paris (FR)

(21) Appl. No.: 15/750,311

(22) PCT Filed: Aug. 2, 2016
(86) PCT No.: PCT/FR2016/052011

§ 371 Date: Feb. 5, 2018

(30) Foreign Application Priority Data
Aug. 6, 2015 (FR) 1501683

(51) Int. Cl. F02K 9/58; F02K 9/96

(52) U.S. Cl. CPC F02K 9/58; F05D 2270/709; F02K 9/96

(57) ABSTRACT

A method of controlling the pressure (PGC) and a mixture ratio of a rocket engine from a pressure setpoint (PGCc) and from a mixture ratio setpoint (RMc), the method comprising regulation delivering control signals for two control valves (VR1, VR2) of said engine, the regulation using a pressure feedback loop. The method further comprises determining an estimated value for the mixture ratio (RMe) used by said regulation, the estimated value for the mixture ratio being obtained by a model that delivers mixture ratio values as estimated from at least one of the two control valve control signals and/or from the measured pressure.

The invention also provides a control device.

### BACKGROUND OF THE INVENTION

The invention relates to the general field of rocket engines. More precisely, it relates to controlling such engines, and in particular to controlling the pressure and the mixture ratio of such engines.

Rocket engines are controlled in particular so as to reach a desired operating point, e.g. on the basis of pressure setpoints and mixture ratio setpoints. The pressure corresponds to the pressure in the combustion chamber of the engine, and the mixture ratio corresponds to the ratio of the oxygen/hydrogen mass flow rate inputted into the combustion chamber.

Traditionally, control valves are operated on the basis of those setpoints, which valves are known to the person skilled in the art as being the valves that enable action to be taken on the engine, and may possibly be constituted by so-called “bypass” valves, for example. The positions of the control valves are controlled in order to reach the pressure and mixture ratio setpoints.

One solution for controlling the engine may be an open loop solution in which the control signals for the control valves are calculated beforehand so that the control signals are delivered on the basis of the setpoints. That said, those solutions are not satisfactory since they present a high level of uncertainty.

Another solution is to use closed-loop regulation. The parameter that is to be regulated (e.g. the pressure or the mixture ratio) is measured, and the measured value is used to correct the regulation. This makes it possible in particular to compensate for exogenic disturbances (acceleration), or even endogenic disturbances (e.g. degradation).

Since a rocket engine is a multi-variable system (two setpoints and a plurality of control signals), it is possible to use a plurality of regulation loops. That said, such loops require measurements of the parameters that are to be regulated.

Certain measurements cannot be taken This applies if measurement modules for measuring one of the two parameters are unavailable or not provided in the system. This occurs frequently for modules that measure mixture ratio since taking that measurement can be complicated. In order to measure the mixture ratio, it is necessary to measure each of the flow rates, or to estimate each of those flow rates. If estimators are used, it is necessary to measure other parameters and such measurements are complex. It may also be necessary to use measurements that are redundant.

In order to mitigate those drawbacks and even if the engine is nevertheless regulated for a first parameter, e.g. pressure, proposals have been made to compensate for variations in the control signals for the control valves so as to maintain a desired mixture ratio.

Such compensation is necessary under such circumstances because the system is a “coupled” system. In other words, there exists interaction between the pressure and the mixture ratio due to the sensitivities of the two control valves. Compensation is generally implemented by inverting a sensitivity matrix, and it may be performed on the basis of maps of controlled values for the control valves.

That said, matrix inversion is not possible for systems that are non-linear, which applies to rocket engines. Linear compensation is thus applicable only in the vicinity of a selected operating point.

The invention seeks specifically to mitis ate the above-mentioned drawbacks, and in particular to provide control over thrust and mixture ratio without requiring the mixture ratio to be measured, and to provide a solution that is appropriate for non-linear systems.

### OBJECT AND SUMMARY OF THE INVENTION

The present invention satisfies this need by Proposing a method of controlling the pressure and a mixture ratio of a rocket engine from a pressure setpoint and from a mixture ratio setpoint, the method comprising regulation delivering control signals for two control valves of said engine, the regulation using a pressure feedback loop.

According to a general characteristic, the method further comprises determining an estimated value for the mixture ratio used by said regulation, the estimated value for the mixture ratio being obtained by a model that delivers mixture ratio values as estimated from at least one of the two control valve control signals and/or from the measured pressure.

There is thus no need to use sensors for measuring the mixture ratio. The invention thus provides a solution that is simple without requiring additional sensors.

It may be observed that the measured pressure is used in the pressure feedback loop, and that this magnitude is therefore regulated: any error in this magnitude is therefore minimal. As a result, the estimate of the mixture ratio is more accurate.

The use of a previously-prepared model also makes it possible to take account of the non-linear nature of the system.

The control valves of said engine may be situated at different locations depending on the thermodynamic cycle of the engine, e.g. in parallel with the turbines or indeed downstream from the propellant tanks.

In a particular implementation, said at least one of the two control valve control signals is a control signal having greater operating sensitivity on the mixture ratio than the other control valve control signal.

In other words, the control signal that is used as input to the model is the signal having the greater influence on mixture ratio variations.

In a particular implementation, the model includes Prior dynamic processing of at least one of the two control valve control signals and of the measured pressure before delivering them to the model, and dynamic processing of the estimated mixture ratio value as obtained by the model.

The model thus has a static portion in which previously-established estimated values for the mixture ratio are obtained by a relationship associating the inputs and the outputs (e.g. relating the control valve control signals, and the pressure, and the resulting mixture ratio that is output), but the values applied as inputs to the model are processed, e.g. by transfer functions using zeros and poles.

In a particular implementation, said model comprises an artificial neural network.

This artificial neural network corresponds to the static portion of the model.

This may advantageously make it possible to perform prior training so that the model supplies satisfactory estimated values for the mixture ratio.

In a particular implementation, an offset is applied to said at least one of the two control valve control signals and to said measured pressure prior to supplying them to said model.

Such an offset may in particular serve to adapt a model designed for other engines to one particular engine, and to do so in simple manner.

In a particular implementation, the method comprises prior training of said artificial neural network, testing said rocket engine, and resetting said artificial neural network in order to deduce said offsets therefrom.

The invention also provides a device for controlling the pressure and a mixture ratio of a rocket engine, the device having an input for receiving a pressure setpoint, an input for receiving a mixture ratio setpoint, and a pressure regulator module delivering control signals for two control valves of said engine, the regulator module using a pressure feedback loop.

According to a general characteristic, the device includes an estimator module for estimating the mixture ratio and including a model delivering to said regulator module values for the mixture ratio that are estimated from at least one of the two control valve control signals and/or from the measured pressure.

The device may be configured to implement the various implementations of the control method as defined above.

It may be observed that the regulator module may be a single-variable module or a multi-variable module.

The invention also provides a system comprising a rocket engine and a device as defined above.

### BRIEF DESCRIPTION OF THE DRAWINGS

Other characteristics and advantages of the present invention appear from the following description given with reference to the accompanying drawings, which show an embodiment having no limiting character.

In the figures:

FIG. 1 is a diagram showing an engine and a control device of the invention;

FIG. 2 shows more precisely a control device of the invention;

FIG. 3 is a diagram of an estimator module of the invention;

FIG. 4 shows an example of a surface that can be used in an estimator module model;

FIG. 5 shows a variant of a control device of the invention; and

FIG. 6 is a diagram showing certain prior steps of a method of the invention.

### DETAILED DESCRIPTION OF AN EMBODIMENT

There follows a description of a method and a device for controlling the pressure and the mixture ratio within a rocket engine.

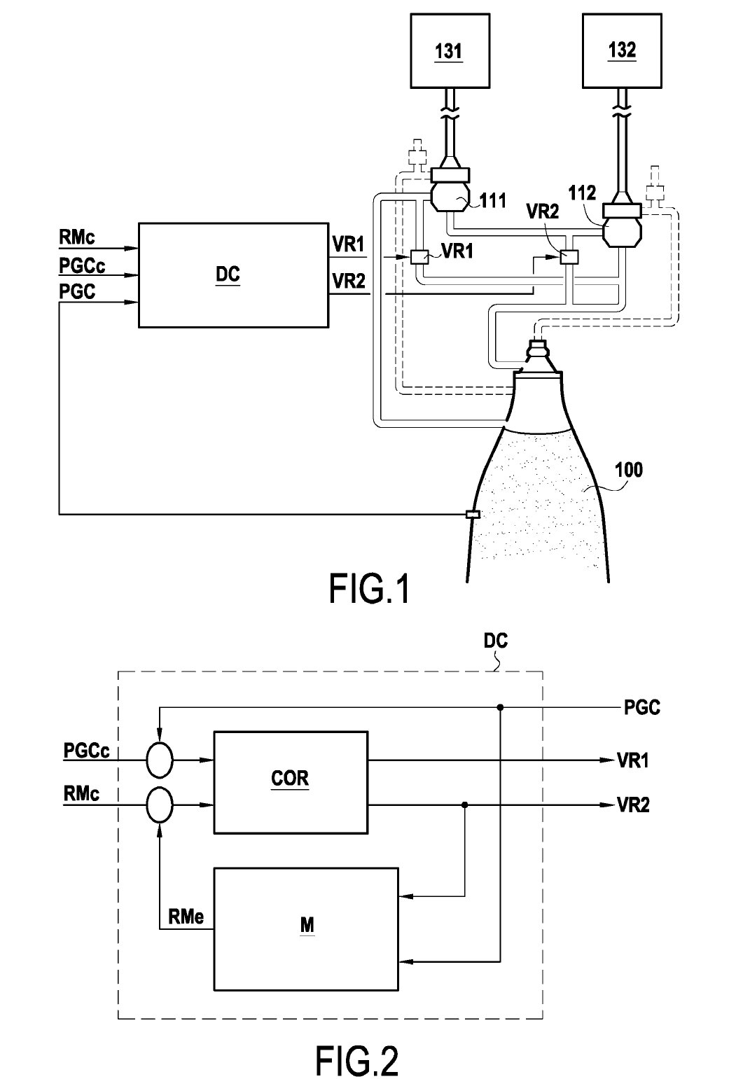

FIG. 1 shows a system comprising a control device DC and a rocket engine. Although the rocket engine in this figure is included in a system of the invention, its internal structure has no hearing on the invention proper.

By way indication, the structure of the engine in FIG. 1 corresponds to the structure described in greater detail in Document EP 2 187 031.

In this example, the engine has two propellant tanks 131 and 132. Downstream from each tank 131 and 132, the engine has a respective pump 111 or 112.

Downstream from the pumps, the engine has two control valves VR1 and VR2 referred to as “bypass” valves and located on the two turbine lines. It may be observed that in the present description the references VR1 and VR2 are used both to designate the control valves and also their control signals, which serve to determine their positions.

The engine also has a combustion chamber, and it is in the combustion chamber that it is desired to regulate the pressure (referenced PGC below) and the mixture ratio.

It may be observed that in the configuration shown, the person skilled in the art knows that the control valve VR2 is the valve that has the greater functional sensitivity on the mixture ratio.

The control device DC for controlling the pressure and the mixture ratio has an input for receiving a pressure setpoint referenced PGCc and an input for receiving a mixture ratio setpoint RMc. In order to regulate pressure in a closed loop, the real pressure PGC in the combustion chamber is measured by a sensor connected to another input of the control device DC.

The control device DC delivers control signals to both control valves VR1 and VR2.

FIG. 2 shows in greater detail the control device DC described with reference to FIG. 1.

As mentioned above, the device DC has inputs for the pressure setpoint PGCc, the mixture ratio setpoint RMc, and the measured pressure PGC, and the device outputs control signals VR1 and VR2 (which signals are for minimizing the errors input to the corrector).

In order to deliver the control signals, the device DC has a corrector COR and an estimator module M. The module M delivers estimated values for the mixture ratio, written RMe, that are estimated on the basis of the pressure PGC and of the control signal VR2, using a model that associates these parameters.

The corrector handles errors firstly between the pressure PGC and the pressure setpoint PGCc (by the feedback loop), and secondly between the estimated mixture ratio RMe and the mixture ratio setpoint RMc. The corrector can thus deliver the control signals VR1 and VR2.

The structure of the corrector COR is analogous to that of a prior art corrector in which it is possible to measure the mixture ratio.

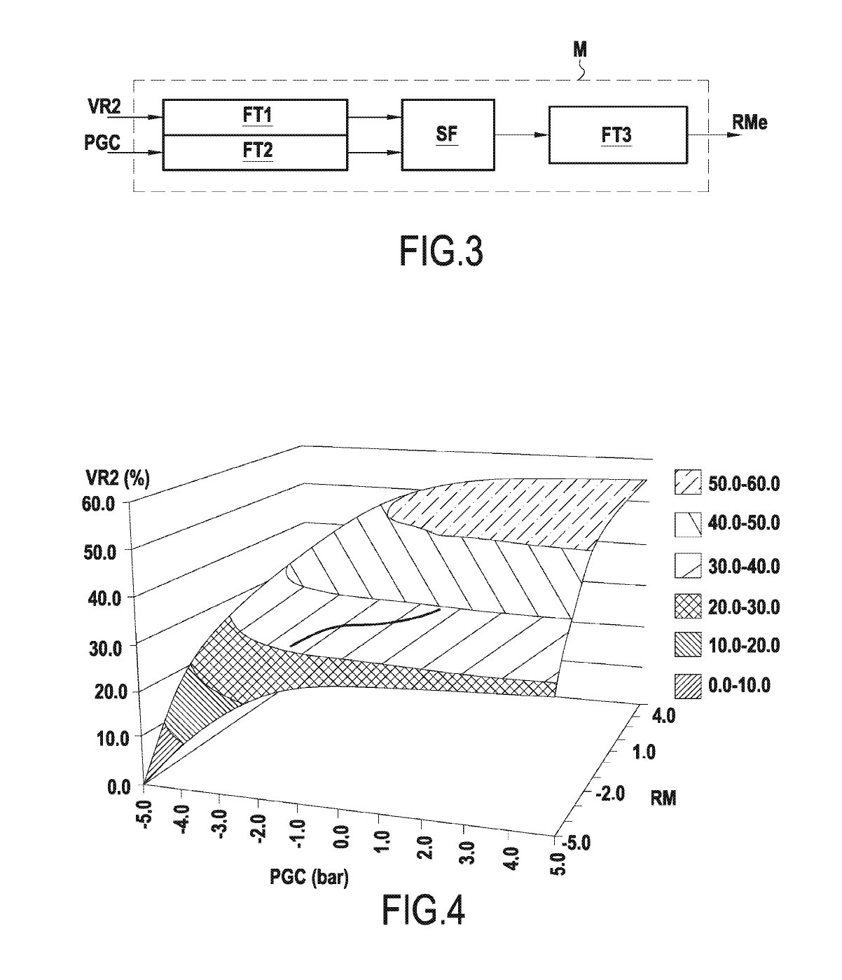

FIG. 3 shows an embodiment of an estimator module M that includes a model SF, e.g. a surface defined by pressure values, values for the control signal VR2, and estimated values for the mixture ratio.

The model SF may comprise an artificial neural network.

This figure also shows the dynamic portion of the estimator module M. The estimator module M includes modules for prior processing of each input to the module M, dynamic processor module FTI processing the control signal VR2 and a processor module FT2 processing the pressure PGC. The model SF delivers values that are processed by a dynamic processor module FT3 subsequently to deliver the estimated value RMe for the mixture ratio.

The dynamic processor modules FT1, FT2, and FT3 may present transfer functions having zeros and poles, and the person skilled in the art knows how to select the form of these functions as a function of the application.

FIG. 4 shows an example of a surface SF defined by pressure values PGC, by values for the control signal VR2, and by estimated values RMe for the mixture ratio. Such a surface can be modeled by an artificial neural network.

In this figure, a bold line represents an example path followed when performing the control method of the invention.

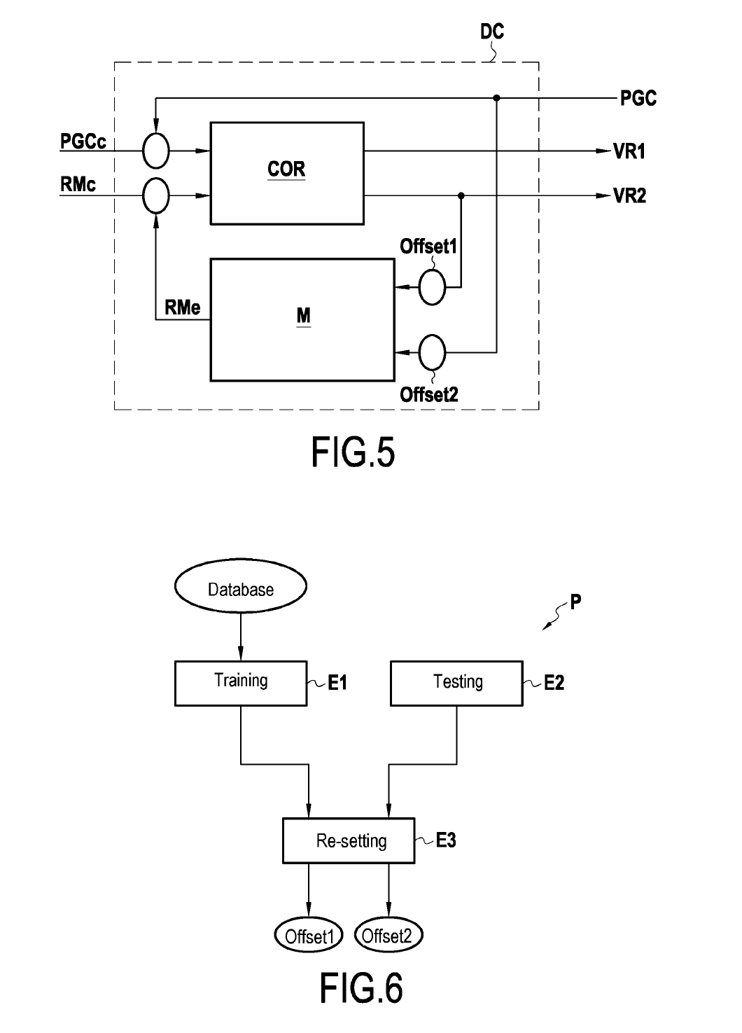

FIG. 5 shows a variant of a control device DC. Elements having the same references as those given in FIG. 2 are identical.

In this figure, there is shown the application of an offset offset1 to the valve control signal VR2 prior to the signal being supplied to the estimator module M.

In analogous manner, there can be seen the application of an offset offset2 to the pressure PGC prior to the pressure being supplied to the module M.

FIG. 6 shows a set of steps P performed prior to controlling a rocket engine in an implementation and an embodiment in which the model includes an artificial neural network.

Prior to performing control, an artificial neural network is subjected to training (step E1). This may be done using a database of rocket engine test data.

The artificial neural network obtained after step E1 could be used for controlling a rocket engine. That said, in order to take account of characteristics that are specific to one particular engine, it is possible to perform tests on that engine (step E2) in order to observe how the pressure, the control signal VR2, and the mixture ratio are associated in that engine.

It is thus possible to reset (step E3) the artificial neural network (or the corresponding surface), and for example to determine the offsets offset1 and offset2 described with reference to FIG. 5.

1. A method of controlling the pressure and a mixture ratio of a rocket engine from a pressure setpoint and from a mixture ratio setpoint, the method comprising regulation delivering control signals for two control valves of said engine, the regulation using a pressure feedback loop, wherein the method further comprises determining an estimated value for the mixture ratio used by said regulation, the estimated value for the mixture ratio being obtained by a model that delivers mixture ratio values as estimated from at least one of the two control valve control signals and/or from the measured pressure.

2. The method according to claim 1, wherein said at least one of the control valve control signals is a control signal having greater operating sensitivity on the mixture ratio than the other control valve signal.

3. The method according to claim 1, including prior dynamic processing of at least one of the two control valve control signals and of the treasured pressure before delivering them to the model, and dynamic processing of the estimated mixture ratio value as obtained by the model.

4. The method according to claim 1, wherein said model comprises an artificial neural network.

5. The method according to claim 1, wherein an offset is applied to said at least one of the two control valve control signals and to said measured pressure prior to supplying them to said model.

6. The method according to claim 4, comprising prior training of said artificial neural network, testing said rocket engine, and resetting said artificial neural network in order to deduce said offsets therefrom.

7. A device for controlling the pressure and a mixture ratio of a rocket engine, the device having an input for receiving a pressure setpoint, an input for receiving a mixture ratio setpoint, and a pressure regulator module delivering control signals for two control valves of said engine, the regulator module using a pressure feedback loop, wherein the device includes an estimator module for estimating the mixture ratio and including a model delivering to said regulator module values for the mixture ratio that are estimated from at least one of the two control valve control signals and/or from the measured pressure.

8. A system including a rocket engine and a device according to claim 7.
